(19) United States
(12) Patent Application Publication
(10) Pub. No.: US 2026/0296434 A1
(43) Pub. Date: Oct. 1, 2026

(54) ADAPTIVE CRUISE CONTROL OF A MOTOR VEHICLE

(71) Applicant: MAGNA Automotive Europe GmbH, Wien (AT)

(72) Inventors: Christoph HOEFER, Hargelsberg (AT); Martin GROSSBICHLER, Aschbach/Steyr (AT); Manuel SACHSE, Rosengarten (DE)

(73) Assignee: MAGNA Automotive Europe GmbH, Wien (AT)

(21) Appl. No.: 19/548,058

(22) Filed: Feb. 24, 2026

(30) Foreign Application Priority Data
Mar. 28, 2025 (EP) 25167154.1

(51) Int. Cl. B60W 30/18; B60W 30/09; B60W 30/14; B60W 40/06; B60W 40/105

(52) U.S. Cl. CPC B60W 30/18154; B60W 30/09; B60W 30/143; B60W 40/06; B60W 40/105; B60W 2520/10; B60W 2552/10; B60W 2554/4044; B60W 2556/50; B60W 2720/10

(57) ABSTRACT

A method for adaptive cruise control of a motor vehicle when the motor vehicle is approaching an unregulated intersection. The method includes capturing, via ADAS sensors of the motor vehicle during an approach of the motor vehicle to an unregulated intersection, external surroundings data of the motor vehicle; performing a geometric calculation of a field of view of the ADAS sensors in a direction towards the unregulated intersection based on the captured external surroundings data and a current position of the motor vehicle; calculating, based on the geometric calculation of the field of view and an intended target path of the motor vehicle, a speed plan for the motor vehicle on the intended target path; and regulating the speed of the motor vehicle based on the calculated speed plan.

### CROSS-REFERENCE TO RELATED APPLICATIONS

The present application claims priority under 35 U.S.C. § 119 to European Patent Publication No. EP 25167154.1 (filed on Mar. 28, 2025), which is hereby incorporated by reference in its complete entirety.

### TECHNICAL FIELD

The present disclosure relates to a method for adaptive cruise control (ACC) of a motor vehicle when the motor vehicle is approaching an unregulated intersection.

### BACKGROUND

It is known that modern motor vehicles can have an ADAS personalization. Existing driver assistance systems (Advanced Driver Assistance Systems, ADAS) offer an array of predefined driving modes, which the driver can select and adapt manually. This enables the driver to have a certain influence on the behaviour and the driving mode of an automated driving function.

Context-dependent ADAS systems are also known: modern ADAS systems take into consideration various driving contexts. They react, for example, to preceding vehicles, take into consideration upcoming curves, and interpret steering wheel inputs in order to adapt the speed in functions such as adaptive cruise control (ACC).

A curve-adaptive longitudinal control can also be used in modern vehicles. Modern ADAS for longitudinal control, such as ACC, adapt themselves to curves by decelerating to an appropriate speed. This adaptation is generally based on curve data which are obtained by vehicle-internal sensors, in particular cameras, and can also use map information which is provided by electronic horizons on the basis of standard-or high-resolution GPS maps.

Modern ADAS systems can also improve safety at intersections. Depending on the sensor configuration, ACC and the emergency functions connected thereto increase safety at intersections in that they recognize oncoming and laterally approaching vehicles. These systems can warn the driver of possible collisions and in some cases introduce emergency braking in order to prevent a collision. Such collision avoidance systems are advantageous especially at unregulated intersections.

However, modern ADAS systems also have some disadvantages, for example with respect to the sensor dependence and costs connected thereto: the performance of existing adaptive cruise control systems (ACC) and collision avoidance systems is strongly dependent on the available sensor equipment and the visibility range of the sensors at intersections. In order to improve the performance for more reliable recognition of approaching vehicles (oncoming vehicles, vehicles from the left or right), more and higher-quality sensors would have to be installed, which would increase the costs. In addition, more advanced recognition algorithms would be necessary to recognize situations more accurately and avoid false alarms, which can result in unnecessary emergency braking.

Even the most advanced sensors cannot overcome restricted visibility conditions at intersections as are caused, for example, by buildings, other vehicles, or other obstacles. Such obstacles can prevent the recognition of oncoming vehicles, in particular vehicles coming laterally from the left or right.

### SUMMARY

It is an object of the present disclosure to specify a method for adaptive cruise control of a motor vehicle when the motor vehicle is approaching an unregulated intersection, which can reliably avoid collisions in the intersection area, enables a prompt forward movement of the motor vehicle, and at the same time contributes to cost-effective production of the motor vehicle.

The object is achieved by a method for adaptive cruise control of a motor vehicle when the motor vehicle is approaching an unregulated intersection, wherein the motor vehicle comprises surroundings sensors for capturing external surroundings data of the motor vehicle, in particular ADAS sensors, wherein during an approach of the motor vehicle to an unregulated intersection, external surroundings data of the motor vehicle are received, a geometric calculation of a field of view of the surroundings sensors in the direction towards the unregulated intersection is carried out on the basis of the external surroundings data of the motor vehicle and the current position of the motor vehicle, wherein depending on the field of view and an intended target path of the motor vehicle, a speed plan for the motor vehicle on the intended target path is calculated, wherein the speed of the motor vehicle is controlled in accordance with the speed plan.

According to the present disclosure, a motor vehicle, when approaching an unregulated intersection in which stopping in dependence of a traffic signal is not required, before driving into a collision or hazard area, the speed of the motor vehicle is adapted, in particular reduced, depending on the field of view of the sensors of the motor vehicle. The field of view of the surroundings sensors is geometrically determined in that the external surroundings data supplied by the surroundings sensors and in particular obstacles recognizable therein for the field of view are taken into consideration, as well as the position of the motor vehicle relative to these obstacles. The intended speed on the planned path of the motor vehicle in the direction of a target path-which can comprise the entry into the unregulated intersection and exit out of the intersection-is adapted depending on the geometrically determined field of view of the sensors.

An “unregulated intersection” is an intersection on which the traffic is not regulated by light signals, in particular traffic signals, nor by arm signals. Unregulated intersections are distinguished as coequal and non-coequal. Intersections at which traffic signs relating to the right-of-way are attached are considered non-coequal. The method according to the present disclosure relates to coequal and non-coequal unregulated intersections.

At present, intersections which are unregulated are not suitably taken into consideration in the existing speed planning processes for longitudinally-directed assistance systems such as ACC. Human drivers generally slow their speed at unregulated intersections in order to assess the presence of intersecting vehicles. On the basis of this assessment, the driver decides whether to decelerate further, possibly to a standstill, or whether to accelerate and drive into the intersection. In contrast to intersections which are regulated by stop signs, a complete standstill at the entry point of the unregulated intersection is not obligatory.

This driver behaviour, namely the selection of a suitable entry speed into an intersection on the basis of the visibility conditions at the intersection, is emulated in a method according to the present disclosure. The visibility range is at least partially determined by the geometric properties of the intersection, such as road width, intersection angle, static obstacles to vision, and by information which can be obtained, for example, from GPS maps and electronic horizon concepts connected thereto or vehicle-internal sensors such as camera and radar.

According to the present disclosure, a suitable speed for the entry into an intersection, in particular the approach to a so-called “stopping point” is determined, wherein preferably the unfavourable case is also taken into consideration that sensor information is not available, as long as the motor vehicle is at a long distance from the intersection.

In accordance with the present disclosure, in this way consideration can be given to the visibility range in an adaptive cruise control (ACC) of a motor vehicle. The ACC system can systematically take into consideration the effects of the visibility range in the speed adaptation. The natural human driving behaviour of driving more slowly during the approach to an unregulated intersection with restricted visibility range is emulated in a speed assistance system according to the present disclosure. A slowing phase at an unregulated intersection is tailored to the specific properties of the intersection, such as the visibility range.

The approach to an intersection is dependent on the specific visibility conditions in the specific individual case. Improved adaptive behaviour occurs during the approach to intersections having restricted visibility range.

The solution according to the present disclosure represents a novel approach to achieve a safe and human-like speed control in longitudinal assistance systems, such as adaptive cruise control (ACC) for motor vehicles, at unregulated intersections in that preferably GPS map data and vehicle-internal sensors are used to derive the intersection geometry and planned manoeuvres, to calculate geometric fields of view in consideration of the intersection geometry and possible obstacles, and achieve a predictive slowing to an appropriate speed until a specific “decision point” is reached, at which the field of view for the sensors is sufficient to recognize other vehicles for collision avoidance. The ego vehicle can thus maintain its speed into the intersection, or even accelerate, or reduce its speed less and avoid unnecessary conservative stopping without impairing the cross traffic. The driving time of the ego vehicle and the energy consumption can be reduced, the safety can be enhanced due to an appropriate speed selection, and human-like driving behaviour can be implemented.

Among other things, the following advantages can be achieved in this way.
(i) Enhanced safety: due to the calculation of the field of view and the planning speeds in order to ensure that the vehicle can always stop safely within the visibility range, the system reduces the risk of collisions with nonvisible objects or vehicles.
(ii) Improved efficiency: the capability of identifying decision points at which the vehicle can no longer decelerate and depend on the sensors for collision avoidance enables a smoother and more efficient navigation through intersections, by which unnecessary stops and delays are avoided.
(iii) Human-like behaviour: the system emulates human driving behaviour in that it adapts the speed of the vehicle to the visibility conditions and the intersection geometry, which results in a more natural and predictable driving experience.
(iv) Enhanced comfort: the cruise control in the closed control loop and the planning offer functions for the adaptive cruise control (ACC) which enhance driving comfort at unregulated intersections.
(v) Versatility: the solution can be applied to various intersection types and scenarios, including right-turn manoeuvres at T-intersections with right-of-way signs, which makes it into a versatile approach for different driving conditions.
(vi) Predictive planning: the system ensures by way of predictive planning and worst-case assumptions that the vehicle is prepared for unexpected situations, and thus enhances the general traffic safety without being dependent on costly sensors.
(vii) Integration with existing technologies: the system preferably uses data from GPS maps, electronic horizons, cloud-based APIs, and/or vehicle-internal sensors and thus enables seamless integration with existing navigation and sensor technologies.
(viii) Shorter travel time: due to the avoidance of unnecessary stops and optimization of the vehicle speed on the basis of the real-time conditions, the solution can contribute to shortening the overall travel time and improving the traffic flow.

Refinements of the present disclosure are specified in the dependent claims, the description, and the appended drawings.

Preferably, in addition to the external surroundings data of the motor vehicle captured by means of surroundings sensors, data from GPS systems and/or data from electronic horizon concepts are used to calculate the speed plan for the motor vehicle on the intended target path.

Preferably, a target reference point is defined on the intended target path so that at the target reference point, the motor vehicle has ended the approach to the unregulated intersection and can adopt a standard speed for driving on the target roadway, wherein a required time which the motor vehicle requires during a movement corresponding to the speed plan until reaching the target reference point is calculated. The target reference point is a point on the target path at which the motor vehicle has ended the entire procedure of the approach to the unregulated intersection, i.e. the entire maneuver of driving to the intersection is completed and the motor vehicle can drive further at a speed typical for the target roadway at this point without reduction of the speed due to the entire entry maneuver into the new roadway.

An available time is preferably calculated which a foreign vehicle, which has been detected in the field of view of the surroundings sensors or which is outside the field of view of the surroundings sensors, requires until reaching the target reference point during a movement at a probable speed, thus at a speed which is probable for the relevant road section and/or possibly dependent on current surroundings conditions such as weather conditions.

In such a method, it is preferably checked whether the required time is less than the available time, wherein, if this is not the case, depending on the field of view and on the intended target path of the motor vehicle, a renewed calculation is carried out of a speed plan for the motor vehicle on the intended target path at a reduced speed. The speed plan is then therefore adapted by a reduction of the speed if reaching the target reference point, preferably in the area of the exit from the intersection, by the motor vehicle is not reached more quickly than by a possible foreign vehicle.

A collision point is preferably calculated, wherein the collision point describes a position of the motor vehicle on the intended target path of the motor vehicle at which the motor vehicle enters a hazard area of a possible collision with a crossing foreign vehicle at the intersection. In particular, the collision point can describe a position of the motor vehicle at which the contour, thus the outer outline of the motor vehicle, enters the hazard area, in particular intersects a connecting line of an intersecting street. The hazard area can preferably be defined so that it begins at an imaginary connecting line of the closest road edge at the intersection of the ego roadway with intersecting roadways. The collision point, thus the point of a possible collision with a crossing vehicle on the target path, therefore, not only lies on the target path, but rather preferably also on this connecting line of the closest outer roadway boundaries of the intersecting roadways. This connecting line can also be referred to as a stopping line and is preferably the line on which the stopping point is located, at which a motor vehicle typically stops when the entry into the target roadway is not possible.

The reduced speed of the new reduced speed plan can provide that a minimum speed is reached at the collision point, for example a standstill at the collision point, but if possible a speed greater than zero at the collision point, preferably less than 5 km/h.

It is preferably checked whether the required time is less than the available time, wherein if this is the case, the speed of the motor vehicle is regulated according to a standard speed, which is not reduced by a collision risk, for driving through the intersection. A reduction of the speed due to a possible collision with a foreign vehicle upon entry into the intersection then does not have to take place, so that a standard speed suitable independently of a collision hazard can be selected for the entry into the intersection.

Preferably, depending on the field of view and on the intended target path of the motor vehicle, the speed plan for the motor vehicle on the intended target path is calculated by means of a numerical optimization method, wherein the optimization method uses a cost function for an efficiency and/or time optimization. In addition to the field of view, a time optimization, therefore rapid forward movement of the motor vehicle, and/or an efficiency optimization, for example energy optimization, therefore plays a role in the determination of the speed plan for approaching the unregulated intersection.

A motor vehicle according to the present disclosure comprises a control unit (having one or more processors) installed in the motor vehicle, which is configured to carry out a method as described above. The speed of the motor vehicle can be regulated by the control unit, at least in the longitudinal direction, during the entry into an intersection.

### DRAWINGS

The present disclosure will be described by way of example hereinafter with reference to the drawings.

FIG. 1 is a schematic representation of an unregulated intersection.

FIG. 2 is a schematic representation of an unregulated intersection and represents a scenario of a right-turning motor vehicle at a T-intersection with controlled right-of-way having various reference variables for a method according to the present disclosure.

FIGS. 3A and 3B are schematic representations of the calculation of a field of view 4 in two variants.

FIG. 4 is a schematic representation of the scenario of a right-turning motor vehicle at a T-intersection with controlled right-of-way from FIG. 2, having further reference variables for a method according to the present disclosure.

FIG. 5 is a schematic representation of calculated signals of a geometrical property calculation during approach to a T-intersection in a method according to the present disclosure.

FIG. 6 is a schematic representation of a situation in which the decision point is reached and free speed planning can take place at the end of a method according to the present disclosure.

FIG. 7 represents an overall block diagram for a method according to the present disclosure.

FIG. 8 is a schematic representation of the result of the application of a method according to the present disclosure to a 90° T-intersection. Strips are shown having the profiles of speed v, time t, curvature c, radius r, and authorization e for the entry into the intersection over the distance.

### DESCRIPTION

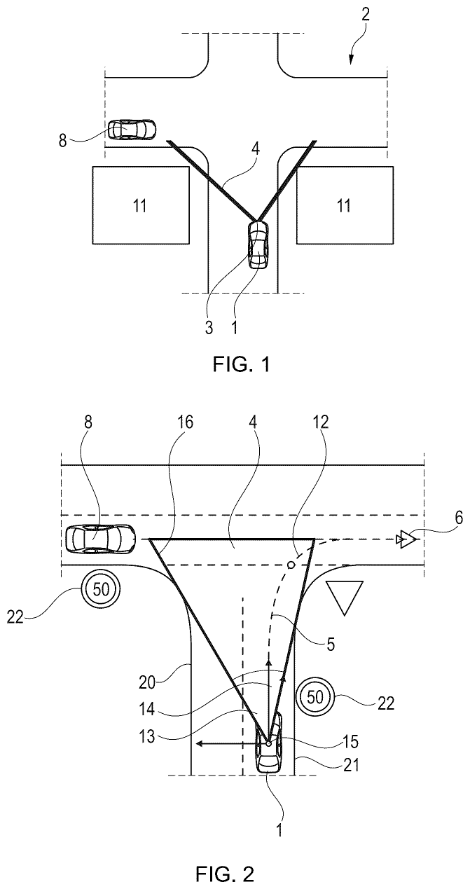

FIG. 1 shows an unregulated intersection as is to be approached and driven through in a method according to the present disclosure.

Even the most advanced surroundings sensors 3 cannot overcome restricted visibility conditions at intersections 2 as are caused, for example, by buildings, other vehicles, or other obstacles 11. As shown in FIG. 1, these obstacles 11 can prevent the recognition of crossing foreign vehicles 8 from the left or right. According to the present disclosure, the speed v of the motor vehicle 1 approaching the intersection 2 can be adapted to the field of view 4, in particular to the longitudinal and/or lateral visibility range, so that collision avoidance systems are optimized.

FIG. 2 shows a scenario of a right-turn maneuver, namely a right-turning motor vehicle 1 at a T-intersection having right-of-way signs, which can be approached using a method according to the present disclosure. The ego vehicle is shown, thus the ego motor vehicle 1, as are the intended and known ego target path 5 for the planned driving scenario, thus the right turn, and the adopted path of the crossing foreign vehicle 8, which approaches from the left on the main road so it is still unrecognizable to the surroundings sensors 3 in this situation, since it is outside the field of view 4 thereof. The motor vehicle 1 travels on a road having left road boundary 20 and right road boundary 21. Speed limits 22 regulate the permitted speed on the road travelled by the vehicle 1, and on the intersecting road, which has the right-of-way over the ego road.

A stopping point 12 is shown in FIG. 2 as the position at which the ego vehicle 1 has to stop in order to enable a crossing vehicle 8 to traverse the intersection 2. In the case of a conservative observation, the left and the right roadway edge define the field of view 4, which is a worst-case assumption. As is apparent, the boundaries of the field of view 4 can be determined for each point along the target path 5 of the ego vehicle 1 by calculating tangents 16 at the curves, which are defined by the left and right road edge in the area of the intersection 2, wherein the tangents 16 lead through the current position of the ego motor vehicle 1, preferably of the surroundings sensor 3 of the motor vehicle 1 or a centre of gravity 15 of the motor vehicle 1. The detection angle for the left and right field of view 4 (left and right of the straight line forwards in the direction of travel) can be calculated therefrom. The turn into the intersection ends with reaching the target reference point 6, which is determined by the algorithm itself.

The following detailed description relates to a right-turn situation at a T-intersection as shown in FIG. 2, which represents an embodiment of the present disclosure.

Data capture at intersections: when the vehicle 1 approaches an intersection 2, the data capture is started automatically by a special logic. The required data for the upcoming intersection 2 are derived from GPS maps, electronic horizons, APIs to cloud-based maps, and/or vehicle-internal sensors, such as camera and/or radar, preferably including: road width and/or speed limit and/or width of the main traffic roads and/or speed limit and/or intersection angle from secondary to main traffic roads and/or radius in the transition from a secondary road to a main road.

The algorithm preferably calculates the following variables proceeding from the current position of the motor vehicle 1: road boundaries, the target path of the ego vehicle 1, the course of the crossing foreign vehicle 8, the stopping point 12.

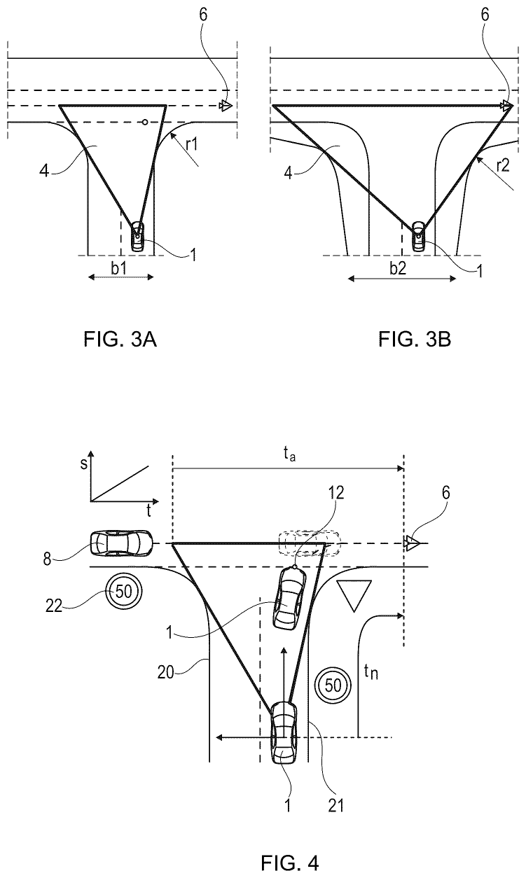

The geometric properties of the current situation are then calculated. The field of view 4 is determined by calculating the detection angles 13, 14 on the left and right sides of the vehicle 1. The centre of gravity 15 of the motor vehicle 1 is preferably used as the basis for the calculation of these angles. The tangents 16 can be defined depending on the vehicle longitudinal direction and left or right road boundary. With the aid of trigonometric functions, the detection angle or angles, for example a left detection angle 13 and a right detection angle 14, is/are then calculated. FIG. 3 shows the calculated field of view 4 for a T-intersection depending on the adopted left and right road boundary.

FIGS. 3A and 3B schematically show the calculation of a field of view 4 in two variants. FIGS. 3A and 3B respectively show the effect of the selected road boundaries as obstacles 11 for the surroundings sensors 3 on the resulting detection angles 13, 14, for example on the left and right of the forward direction.

The calculation rule for the determination of the collision point 9 takes into consideration the geometry of the vehicle 1. A bounding box is created for this purpose, which extends over the width and length of the vehicle 1 and is adapted in accordance with its current alignment, as shown in FIG. 4. The collision point 9 is defined as the centre of gravity, at which the bounding box and the stopping line intersect for the first time, by an iterative check. On the basis of this definition, the collision point 9 is reached before the above-mentioned stopping point 12 is reached. More precisely, when the centre of gravity 15 of the motor vehicle 1 reaches the collision point 9, one of the vehicle edges reaches the stopping point 12.

FIG. 4 schematically shows this situation for calculating collision point 9, target reference point 6, and for calculating the required time tₙ and the available time tₐ. The foreign vehicle 8 approaches at adopted constant speed—if the most unfavourable case is assumed, this corresponds to the speed limit on the main road—the ego vehicle, motor vehicle 1, approaches the intersection 2 at the speed v defined by the speed planning function vₚ.

Speed limit for the collision point calculation: if the visibility range is not sufficient, the motor vehicle 1 will decelerate in the direction of the collision point 9. The conservative target speed at the collision point 9 is fixed at 2 km/h, but can be calibrated for specific applications. The speed of 2 km/h enables a gradual entry into the intersection 2 in bad visibility conditions until the detection angle 13, 14 offers sufficient visibility for the peripheral sensors 3 to confirm an appropriate line of sight. After the stopping point 12, at which the road is completely visible, the speed limit applies for the main road.

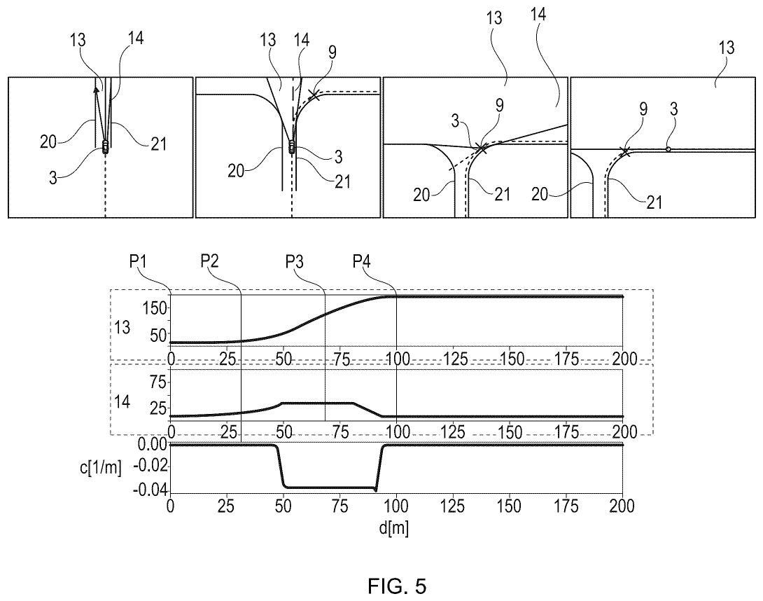

Examples of calculated signals of a geometrical property calculation for a T-intersection are shown in FIG. 5.

FIG. 5 shows a geometrical analysis of a 90° T-intersection. The development of the conservatively calculated field of view 4 based on the current ego vehicle position is shown. Detection angles on the left 13 and right 14, the vehicle longitudinal direction is represented as a dashed line, a cross marks the collision point 9.

The following positions are shown during approach to the intersection 2: target path position 0 m as P1, target path position 30 m as P2, target path position 68 m, collision point as P3, and target path position 100 m as P4.

Speed planning: this function block assesses a continuous speed plan vₚ along the upcoming target path 5 of the ego vehicle 1 in consideration of the following input data, which can vary in some embodiments: position of the vehicle 1, electronic horizons, in particular upcoming curvature, inclination and vectors of the legal speed limit, possibly ADAS sensors for improving the data of the electronic horizons, current vehicle status signals such as vehicle speed and acceleration.

In preferred embodiments, this function can contain a numerical optimization approach in which a cost function is used which can be tailored for efficiency optimization or time optimization on the basis of given factors and restrictions imposed by the driver, the vehicle, and the road itself, in that for example slope, curvature, and legal speed limit are taken into consideration. The speed limit takes into consideration the speed restrictions both on secondary roads and on main roads.

The specific algorithm can be, for example, an advanced approach as described above, or also a simple planner solely based on kinematics, for example.

It is to be noted that the speed planning uses the legal speed limit specified by the electric horizons as a standard feature, but a reverse loop “plan in speed reduction (stopping point)” S7 could possibly change this input to force a low and/or zero speed—the above-mentioned speed limit for the collision point 9—at the collision point 9, see further description of this functionality below.

The time calculation is based on the results of the geometrical calculations and the current speed planning.

Target reference point calculation: first the target reference point 6 for the time calculation has to be determined on the basis of the previously planned speed of the ego vehicle 1 along the ego target path 5. The target reference point 6 represents the end of the turning maneuver at which the ego vehicle 1 reached an appropriate stationary speed so that it incorporates itself smoothly into the main traffic flow without impairing the other vehicles. In some embodiments, the technical definition of the target reference point 6 is the location at which the ego vehicle 1 reaches the target speed-the highest speed on the main traffic road. On curvy roads or in the case of traffic, additional conditions are required to determine a reasonable target reference point 6. In curves, for example, the permissible highest speed on the main road cannot be reached safely, so that another condition can be used, for example based on the acceleration of the ego vehicle 1. In this case, the target reference point 6 could be defined as the point at which the acceleration of the ego vehicle 1 drops below a threshold value after passing over the stopping point 12, which indicates that a stationary driving situation is achieved after the acceleration on the main road. The last-mentioned option offers flexibility in the definition of a target reference point 6, even on curvy road sections, on which the target speed is possibly never reached.

Calculation of the required time tₙ: this function calculates the duration which the ego vehicle 1 requires to carry out the planned maneuver at the planned speed along the ego target path 5. From the relationship between the planned ego speed profile and the distance of the ego vehicle 1 to the previously calculated target reference point 6 via the ego target path 5, the required time tₙ can be calculated. The visualization of the required time tₙ is shown in FIG. 4.

In some embodiments, an additional safety span, which can be calibrated, can be added to the time calculation. Overall, the calculated required time tₙ defines the time span which the ego vehicle 1 requires to drive through the intersection 2 and incorporate itself smoothly into the main road traffic if the currently active speed plan vₚ is taken into consideration.

Calculating the available time tₐ: the available time tₐ is calculated as the distance of a potentially crossing vehicle 8, which is located at the intersection point of the left envelope line of the field of view 4 and the target distance of the crossing vehicle 8, divided by the constant speed of the crossing vehicle (see FIG. 4). In the most unfavourable case, it is assumed that the constant speed corresponds to the highest speed on the main road.

A check then takes place as to whether the required time tₙ is less than the available time tₐ: at the beginning, the field of view 4 is typically small because the ego vehicle 1 is still far away from the intersection 2 (see FIG. 4, left picture). Therefore, the time tₙ which the ego vehicle 1 requires to reach the target reference point 6 is typically longer than the time which the potentially crossing vehicle on the main road requires (=available time tₐ). At the beginning of the calculation, the condition required time tₙ<available time tₐ is therefore not met. As a result, a loop back to the speed planning is carried out by the block “set stopping speed”, by which new speed planning vₚ is triggered, during which the speed limit at the collision point 9 is set to the “speed limit for the collision point” (for example, 2 km/h). This conservative speed plan vₚ, which provides stopping at the collision point 9 (or decelerating to the “speed limit for the collision point”) is executed further by the vehicle 1. In the next iteration, in which the vehicle 1 has moved forward somewhat and therefore the visibility range conditions have changed, the process is repeated until the vehicle reaches a point at which the condition required time tₙ<available time tₐ is met, which means that the decision point 17 is reached.

Decision point 17 reached—Unrestricted speed planning: if the condition required time tₙ<available time tₐ is met, the calculated “unrestricted” speed plan is valid, since the current visibility range 4 is sufficient to drive further safely without stopping at the collision point 9 having to be planned. It is to be noted that this “unrestricted” speed plan vₚ does not include stopping at the collision point 9 and therefore possibly permits an acceleration in order to reach a higher speed v during the approach to the intersection 2. This is permitted since the ADAS of the ego vehicle 1 can still make use of sensors for collision avoidance functions due to the sufficient visibility range in order to carry out the maneuver safely, and the ego vehicle 1 can turn into the intersection 2.

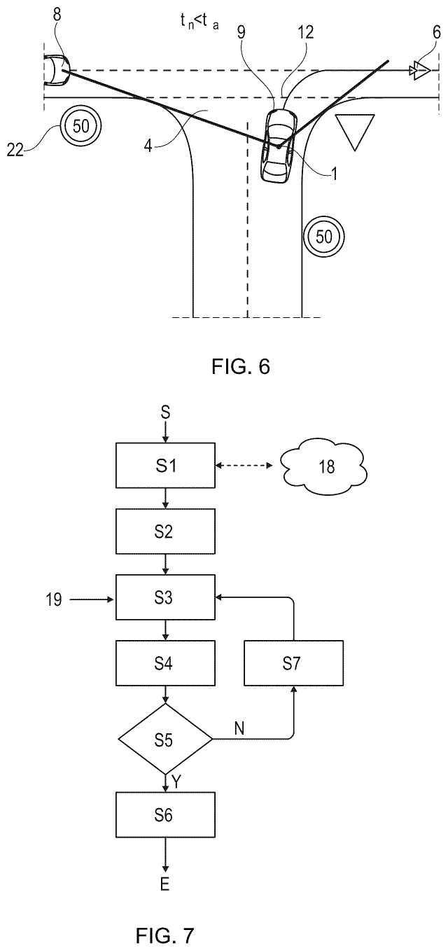

FIG. 6 shows a situation in which the decision point 17 is reached and free speed planning can take place: at this time, sufficient visibility range or field of view 4 is present—in this example to the left—so that there is no necessity in the speed plan vₚ to conservatively reduce the speed v down to a standstill, but rather the controller can depend on the ADAS sensor for collision avoidance. Independently thereof, the adaptive cruise control ACC plans a free speed only in consideration of the previously indicated inputs to the speed planning function.

FIG. 7 represents an overall block diagram for a method according to the present disclosure. The overall functionality of a method according to the present disclosure is shown in FIG. 7. At the defined decision point 17, the algorithm ends and permits the vehicle 1 to plan the speed v freely without forcing a stop at the collision point 9 (“optimal velocity” ov). In comparison thereto, a conservative approach (“conventional velocity” cv) would always provide a stop at the collision point 9, which would result in an unnecessary increase of the driving time and consumption, and in non-human-like behaviour.

FIG. 7 shows: the start S, intersection data capture S1, calculation of geometrical properties S2, speed planning S3, time planning S4, comparison of required time <available time S5, if the check according to S5 results in a yes Y, then decision point reached-unrestricted speed planning S6 follows, otherwise, in the case of no N, the step plan in speed reduction (stopping point) S7 follows and S3 again. E is the end of the method.

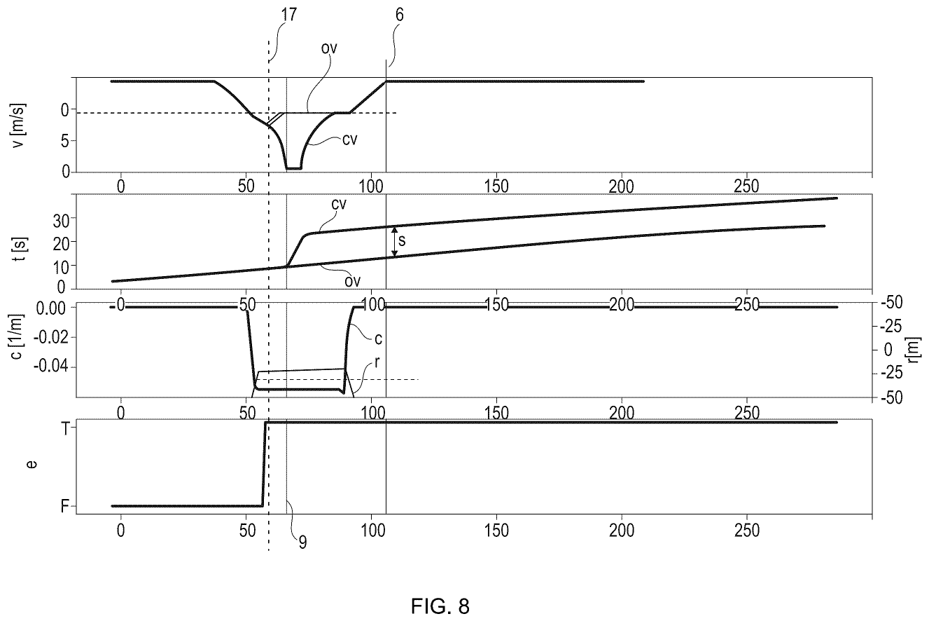

Finally, FIG. 8 shows the result of an application of a method according to the present disclosure to a 90° T-intersection. Strips are shown from top to bottom having the profiles of speed v, time t, curvature c, radius r, and authorization e to enter the intersection over the distance. The decision point 17 is shown as a dashed line. The end of the turning maneuver and the calculation according to the present disclosure are located at the target reference point 6. Both a conventional value cv, without optimization of the curve beginning, and also an optimized value ov according to the present disclosure are shown in the graphs for the speed v and for the time t. A time s saved by the method is apparent.

The present disclosure therefore represents a novel approach to achieve a safe and human-like cruise control in longitudinal assistance systems, such as an adaptive cruise control (ACC) for motor vehicles at unregulated intersections. GPS map data and vehicle-internal sensors can be used here in order to derive the intersection geometry and planned manoeuvres, calculate geometrical visibility ranges in consideration of the intersection geometry and possible obstacles, and a predictive slowing to an appropriate speed until a specific “decision point” is reached, at which the visibility range for the sensors is sufficient to recognize other vehicles for collision avoidance, be planned, and carried out. The ego motor vehicle 1 can thus maintain its speed into the intersection or accelerate or reduce it less than is otherwise typical and avoid unnecessary conservative stopping without impairing the cross traffic, reducing the driving time of the ego vehicle 1 and its energy consumption. The safety is enhanced by an appropriate speed selection and human-like driving behaviour is implemented.

The method can be used, inter alia, for turning right and turning left at T-intersections and for turning right and turning left at X-intersections and, for example, when merging lanes.

### LIST OF REFERENCE SYMBOLS

1 motor vehicle
2 intersection
3 surroundings sensor
4 field of view
5 target path
6 target reference point
7 target roadway
8 foreign vehicle
9 collision point
10 hazard area
11 obstacle
12 stopping point
13 left detection angle
14 right detection angle
15 centre of gravity
16 tangents
17 decision point
18 electronic horizon, GPS data, API data
19 update of vehicle position, electronic horizon, ADAS sensors, vehicle status
20 left road boundary
21 right road boundary
22 speed limit
b1, b2 width
c curvature
cv conventional value
d distance
e authorization to enter
E end
F false
ov optimized value
r, r1, r2 radius
s time saved
S start
T true
t time
tn required time
ta available time
v speed
vp speed plan
P1 target path position 0 m
P2 target path position 30 m
P3 target path position 68 m, collision point
P4 target path position 100 m
S1 intersection data capture
S2 calculation of geometric properties
S3 speed planning
S4 time planning
S5 comparison of required time<available time
S6 decision point reached-unrestricted speed planning
S7 plan in speed reduction (stopping point)
Y yes
N no

What is claimed is:

1. A method for adaptive cruise control of a motor vehicle, the method comprising:
capturing, via ADAS sensors of the motor vehicle during an approach of the motor vehicle to an unregulated intersection, external surroundings data of the motor vehicle;
performing a geometric calculation of a field of view of the ADAS sensors in a direction towards the unregulated intersection based on the captured external surroundings data and a current position of the motor vehicle;
calculating, based on the geometric calculation of the field of view and an intended target path of the motor vehicle, a speed plan for the motor vehicle on the intended target path; and
regulating the speed of the motor vehicle based on the calculated speed plan.

2. The method of claim 1, wherein the speed plan of the motor vehicle is further calculated based upon captured GPS data and/or data from electronic horizon concepts.

3. The method of claim 1, further comprising determining a target reference point on the intended target path.

4. The method of claim 3, wherein at the target reference point, the motor vehicle ends its approach to the unregulated intersection and adopts a standard speed for traveling on a target roadway.

5. The method of claim 4, further comprising calculating a time required by the motor vehicle during a movement corresponding to the speed plan until reaching the target reference point.

6. The method of claim 5, further comprising:
calculating an available time of a foreign vehicle detected in the field of view of the ADAS sensors during a movement at a probable speed until reaching the target reference point, or
calculating an available time of the foreign vehicle detected outside the field of view of the ADAS sensors during the movement at the probable speed until reaching the target reference point.

7. The method of claim 6, further comprising determining whether the time required by the motor vehicle is less than the available time of the foreign vehicle.

8. The method of claim 7, further comprising conducting, when the time required by the motor vehicle is determined to be greater than the available time of the foreign vehicle, a second calculation of the speed plan at a reduced speed for the motor vehicle based on the field of view and the intended target path of the motor vehicle.

9. The method of claim 8, further comprising calculating a collision point that describes a position of the motor vehicle on the intended target path, at which the motor vehicle enters a hazard area of a possible collision with a foreign vehicle that is crossing at the intersection.

10. The method of claim 9, wherein the reduced speed comprises a minimal speed at the calculated collision point.

11. The method of claim 9, wherein the reduced speed causes a standstill of the motor vehicle at the collision point.

12. The method of claim 9, wherein the reduced speed is a speed greater than zero and less than 5 km/h.

13. The method of claim 7, further comprising regulating, when the time required by the motor vehicle is determined to be less than the available time of the foreign vehicle, the speed of the motor vehicle to a standard speed which is not reduced by a collision risk, for driving through the intersection.

14. The method of claim 1, wherein speed plan for the motor vehicle on the intended target path is calculating via of a numerical optimization method.

15. The method of claim 14, wherein the optimization method uses a cost function for an efficiency optimization and/or a time optimization.

16. A motor vehicle, comprising:
a control unit including one or more processors configured to perform operations including:
capturing, via ADAS sensors of the motor vehicle during an approach of the motor vehicle to an unregulated intersection, external surroundings data of the motor vehicle,
performing a geometric calculation of a field of view of the ADAS sensors in a direction towards the unregulated intersection based on the captured external surroundings data and a current position of the motor vehicle,
calculating, based on the geometric calculation of the field of view and an intended target path of the motor vehicle, a speed plan for the motor vehicle on the intended target path, and
regulating the speed of the motor vehicle based on the calculated speed plan.
